(19) United States
(12) Patent Application Publication
(10) Pub. No.: US 2011/0101261 A1
(43) Pub. Date: May 5, 2011

(54) FUNCTIONAL CONSTRUCTION ELEMENT AND A METHOD FOR PRODUCING THE SAME

(76) Inventor: Felix Von Limburg, Magdeburg (DE)

(21) Appl. No.: 12/735,213

(22) PCT Filed: Dec. 19, 2008
(86) PCT No.: PCT/EP2008/010902

§ 371 Date: Dec. 10, 2010

(30) Foreign Application Priority Data
Dec. 21, 2007 (DE) 10 2007 062 125.8

(51) Int. Cl. C04B 14/06; E04B 1/74

(52) U.S. Cl. 252/62; 106/817; 524/8

(57) ABSTRACT

The invention relates to a functional construction element and a method for producing the same. Such a functional construction element is used e.g. as a sound absorbing wall or as an insulation wall. For providing a functional construction element and a method for producing the same, according to which the functional construction element has a simpler and more stable structural design and a longer service life, the invention provides the method for producing a functional construction element according to claim 1, comprising the following steps: a) producing a dispersion with a liquid and hardenable carrier component as a main phase and at least one functional component, which is dispersed in said carrier component, as a secondary phase; b) initiating a segregation process of the dispersion; and c) hardening the dispersion in a partially segregated state so that the concentration of the functional component will increase towards one side of the functional construction element.

The present invention relates to a functional construction element and a method for producing the same. Such a functional construction element is used e.g. as a sound absorbing wall or as an insulation wall.

A conventional functional construction element comprises three layers: a supporting inner layer, a functional layer and an outer layer. The supporting inner layer provides structural strength, the functional layer provides a desired function, e.g. a heat-insulation or sound-absorbing function, and the outer layer holds the functional layer on the support layer, covers the functional layer and forms e.g. an externally visible part of a cladding. The layers are mechanically interconnected through connection elements, such as pins, anchors or the like.

At the connection points, cracks may form on the inner and/or outer layer, especially in the case of changeful environmental conditions, such as major temperature variations, so that the connection elements may break away and the functional construction element may be damaged.

It is the object of the present invention to provide a functional construction element and a method for producing the same, according to which the functional construction element has a simpler and more stable structural design and a longer service life.

For achieving the object of the present invention, the invention provides the method for producing a functional construction element according to claim 1, comprising the following steps: a) producing a dispersion with a liquid and hardenable carrier component as a main phase and at least one functional component, which is dispersed in said carrier component, as a secondary phase; b) initiating a segregation process of the dispersion; and c) hardening the dispersion in a partially segregated state so that the concentration of the functional component will increase towards one side of the functional construction element. Due to the strong accumulation of the functional component on one side of the functional construction element, a structural design is created, which allows various characteristics to be combined in the functional construction element, said characteristics being otherwise only achieved in multi-layer components. For example, a smooth transition from the statically supporting carrier component to the functional component is accomplished in the functional construction element produced in accordance with the method according to the present invention. The monolithic functional construction element produced in accordance with the method according to the present invention unites the advantages of easier production and of a longer service life, so as to fulfil the high demands on modern functional construction elements, and offers, in comparison with a conventional functional construction element, various advantages with regard to cost of material, production or manufacturing costs, ecobalance and simplicity.

Preferred embodiments are claimed in the subclaims.

It may prove to be useful, when the carrier component contains a binder comprising at least a certain percentage of a hydraulic binder, of a latent-hydraulic binder, of a pozzolanic reacting binder, or of a plastic material. Such binders are well suited for use in building materials.

It may prove to be advantageous when the carrier component comprises at least a certain percentage of cement, plaster, anhydrite, loam, clay, bitumen, polyurethane or of some other artificial binder. Such binders are ideally suited for use in building materials.

In order to improve the result that can be achieved by the present invention still further, the carrier component can contain a depolymerized liquid, preferably depolymerized water. For obtaining such a carrier component, water has preferably added thereto a depolymerizer, cement as a binder and other additives, whereupon it is mixed in a high-performance mixer so as to form a suspension. This suspension is then used as a carrier component within the framework of the method according to the present invention. Sand and/or gravel having a grain size of <2 mm and <16 mm, respectively, are added as a functional component and are then mixed with the carrier component, e.g. in a ready-mix truck. The use of the de-polymerized liquid, in particular of the depolymerized water, within the framework of the method according to the present invention has the advantages that the suspension to be used as a carrier component will not segregate and will have an excellent homogeneity, that high-strength concrete can be produced by low water/cement ratios, that high early and ultimate strengths can be achieved, and that the concrete has a high density and a high resistance to chemical attacks. The use of the depolymerized liquid, in particular of the de-polymerized water, within the framework of the method according to the present invention has, as far as processing is concerned, the special advantages that shaking of the dispersion comprising the carrier component and the functional component(s) is not necessary, but that the dispersion will concentrate and de-aerate itself automatically so that the production will proceed smoothly. Other advantages are the following ones: no transmission of vibrations during placement; less wear of formwork; shorter placing-of-concrete times and shorter creation times; better encompassment of complicated and narrow armourings; no compacting faults; fast self-levelling and higher placement rates.

It may be of advantage when a functional component comprises a plurality of gas bubbles. The gas bubbles trapped in the carrier component impart to the functional construction element excellent insulating and sound absorbing characteristics. The concentration of the gas bubbles is preferably selected such that the gas bubbles are arranged directly adjacent to one another on one side of the functional construction element to be produced and that the functional construction element has a foam structure on this side. An open or open-cell foam structure normally provides good sound absorbing characteristics, whereas a closed or closed-cell foam structure has good heat insulating characteristics.

It may, however, also prove to be advantageous when a functional component comprises a plurality of solid particles. The solid particles can be purposefully selected in accordance with the property profile of the functional construction element, and they guarantee a higher strength of the functional construction element in comparison with the gas bubbles. The concentration of the solid particles is preferably chosen such that the solid particles are arranged directly adjacent to one another and are in contact with one another on one side of the functional construction element to be produced.

It may be useful when the particles have a structure that cannot be penetrated by the carrier component. This has the effect that the particles are only encompassed by the carrier component, without being penetrated, so that they will reliably fulfil their intended function for a long period of time, when the functional construction element has been finished. This effect can be supported e.g. by depolymerizing water which is contained in the carrier component so that also large-pored particles will only be encompassed, but not penetrated by the carrier component.

It may, however, also be helpful when the particles contain gas pockets. Like the gas bubbles, the gas pockets impart to the functional construction element excellent insulating and sound absorbing characteristics, but they have a higher strength and durability in comparison with gas bubbles.

It may also be of advantage when the particles contain a heat insulating and/or sound absorbing material. Within the framework of the method according to the present invention, the heat insulating and/or sound absorbing material can, in the form of the particles, be integrated and embedded in the monolithic functional construction element in a particularly simple and effective manner, so that the functional construction element will combine excellent insulating and sound absorbing characteristics with excellent static characteristics.

It may prove to be useful when the particles contain at least a certain percentage of a natural substance, preferably a vegetable matter such as wood, straw, cork, natural rubber, or of a natural rock such as sand, gravel, volcanic rock such as pearlite or pumice; or of a synthetic substance such as a synthetic material, polystyrene, or of an artificial rock such as expanded clay. Such substances can normally be obtained at low cost, they have excellent insulating and/or sound absorbing characteristics and they are normally weatherproof. For example, car tyres or various other residual, waste and/or scrap products can be recycled, and, after having been broken up (e.g. by shredding), they can be used as a functional component. Within the framework of the method according to the present invention, such substances can be integrated and embedded in the monolithic functional construction element in a particularly simple and effective manner, so that the functional construction element will combine excellent insulating and sound absorbing characteristics with excellent static characteristics.

It may be useful when a functional component has a density which is different from that of the carrier component. This will substantially support the segregation process under the influence of the force of gravity.

It may prove to be convenient when step a) includes stirring of the dispersion and/or step b) includes shaking of the dispersion. By stirring the dispersion, the functional component can be distributed uniformly in the carrier component. By shaking the dispersion, the time required for the segregation process can be reduced substantially.

It may prove to be advantageous when step b) includes the segregation of the dispersion under the influence of the force of gravity. This step can be accomplished without making use of any special aids.

It may prove to be useful when a reinforcing component is embedded in the carrier component. The reinforcing component can thus be arranged and anchored at a desired position and/or with a desired orientation in the carrier component.

It may prove to be particularly useful when the reinforcing component comprises an armouring element. The strength of the functional construction element can thus be increased to a significant extent. The reinforcing component can be an armouring means consisting of metal or of a plastic material, or it may comprise a fibrous or textile reinforcing material.

A particularly preferred aspect of the present invention refers to a monolithic functional construction element produced by the method according to one of the preceding embodiments, the functional construction element being here implemented as a functional construction plate. The functional construction element produced in accordance with the method according to the present invention unites the positive characteristics of a conventional multi-layer functional construction element and has a much more compact structure than such a conventional functional construction element. The connection elements used for connecting the various layers of a conventional multi-layer functional construction element can be dispensed with completely. It follows that the functional construction element produced in accordance with the method according to the present invention also has a much simpler structural design and a substantially reduced liability to failure.

It may prove to be helpful when the functional construction element is implemented as a heat insulating and/or sound absorbing element. Such functional construction elements can be produced particularly well by the method according to the present invention. The functional construction element produced in accordance with the method according to the present invention is preferably used as a cladding element.

It may prove to be advantageous when the functional construction element comprises, between two opposed sides, three zones having an essentially identical thickness, the first and the second boundary zones defining the opposed sides of the functional construction element, whereas a transition zone is defined between the boundary zones, a volume share of a functional component in one of said boundary zones being <=25%, whereas in the transition zone it is >25% and <=75%, and in the other boundary zone it is >75%. Volume shares of this kind proved to be useful in tests.

It may prove to be particularly advantageous when the volume share of a functional component in one of said boundary zones is <=10%, whereas in the transition zone it is >10% and <=90%, and in the other boundary zone it is >90%. Volume shares of this kind proved to be useful in tests.

It may prove to be convenient when the concentration of a functional component increases essentially linearly or exponentially between two opposed sides of the functional construction element. It is thus possible to adjust the property profile of the functional construction element in a particularly advantageous manner for preferred cases of use of the functional construction element.

It may also be useful when the functional construction element comprises two functional components whose concentrations increase towards different sides of the functional construction element. It is thus possible to adjust the property profile of the functional construction element in the individual zones of the functional construction element in a particularly advantageous manner.

It may also prove to be advantageous when the functional construction element is implemented as a roof element. The functional construction element can selectively be implemented as a total roof or as a roofing stone (cf. roofing tile); in this case, the total roof is defined by a plurality of roofing stones. The side of the functional construction element with the accumulated functional component can then face either outwards or inwards, depending on the function that is desired (e.g. heat insulation and/or sound absorption).

It may also prove to be convenient when the functional construction element is implemented as a floor element. The functional construction element can selectively be implemented as a total floor or as a floor stone (cf. floor tile); in this case, the total floor is defined by a plurality of floor stones. The side of the functional construction element with the accumulated functional component can then face either upwards or downwards, depending on the function that is desired (e.g. heat insulation and/or sound absorption).

It may also prove to be helpful when the functional construction element has added thereto a dye. The functional construction element can then be implemented and designed in accordance with optical and aesthetic aspects.

Preferred embodiments of the invention will be described in detail hereinbelow with reference to the enclosed drawings.

### SHORT DESCRIPTION OF THE DRAWINGS

FIG. 1 shows a schematic view of a dispersion for a functional construction element produced in accordance with the method according to the present invention after step a) of the method according to the present invention.

FIG. 2 shows a schematic view of a dispersion for the functional construction element produced in accordance with the method according to the present invention in step b) of the method according to the present invention.

FIG. 3 shows a schematic view of a dispersion for the functional construction element produced in accordance with the method according to the present invention after step c) of the method according to the present invention.

FIG. 4 shows a simplified schematic view of a functional construction element produced in accordance with the method according to the present invention and comprising a matrix and an additive, for explaining a mathematical model of the functional construction element.

FIG. 5 shows a diagram for illustrating the concentrations of the matrix and of the additive of the functional construction element in relation to the distance from a base area of the functional construction element.

### DETAILED DESCRIPTION OF THE PREFERRED EMBODIMENTS

The invention relates to a method for producing a functional construction element, comprising the following steps: a) producing a dispersion 1 with a liquid and hardenable carrier component 2 as a main phase and at least one functional component 3, which is dispersed in said carrier component 2, as a secondary phase; b) initiating a segregation process of the dispersion 1; and c) hardening the dispersion 1 in a partially segregated state so that the concentration of the functional component 3 will increase towards one side S1 of the functional construction element.

The most important terms will be explained hereinbelow:

A dispersion 1 is, within the framework of the present description, a heterogeneous mixture of at least two substances which are not or hardly soluble in one another and which do not or hardly chemically bond to one another. One substance (secondary phase or functional component) is dispersed as finely as possible in another substance (main phase or carrier component). The individual phases can be clearly limited from one another and they can be separated from one another by physical methods (e.g. filtering, centrifugation), or they segregate on their own (sedimentation). When the dispersion 1 contains a liquid main phase and a solid secondary phase, it is referred to as suspension. The secondary phase or functional component can have an arbitrary form within the scope of the present invention, e.g. gaseous (in the form of gas bubbles), solid (e.g. in the form of solid particles, in particular in the form of granulate material, bulk material, grains, capsules, etc.), liquid (e.g. paraffin), or it can have the form of a mixed phase (solid cover with liquid/gaseous core).

A carrier component 2 is, within the frame work of the present description, a component containing a binder so as to harden the dispersion 1 in a desired state. The carrier component 2 forms a matrix M of the functional construction element to be produced in accordance with the method according to the present invention. The matrix M itself can consist of cement or of a water/cement mixture or of other hydraulic binders with latent-hydraulic binders or in combination with pozzolanic reacting binders and/or in combination with plastic materials, or it can consist exclusively of plastic materials and/or plastic material combinations.

The functional component 3, 4 is, within the framework of this description, any additive that can be admixed to the carrier component 2 so as to impart to the functional construction element to be produced in accordance with the method according to the present invention a specific function, in particular a heat insulating and/or sound absorbing function. Each functional component 3, 4 of the dispersion 1 is contained in the carrier component 2 in the form of discrete units (bubbles, grains, capsules, strips, chips, etc., in a hollow or porous form or as solid material) and in a finely dispersed form. The largest diameter of the discrete units is preferably 0.1 mm to 10 m, preferentially 1 mm to 5 mm. The volume share of the functional component 3, 4 in relation to the total volume of the dispersion 1 or the total volume of the functional construction element to be produced is preferably between 25% and 75%, preferentially between 40% and 60%, even more preferentially 50%. Particularly suitable additives are: a) natural substances, e.g. vegetable matter such as wood, straw, cork or natural rubber; natural rock such as sand, gravel, volcanic rock such as pearlite or pumice; and b) synthetic substances such as synthetic material, synthetic rubber or polystyrene; and artificial rock such as expanded clay. Also other additives are to be taken into account. For imparting various functions to the functional construction element to be produced in accordance with the method according to the present invention, the carrier component 2 can have added thereto various functional components 3, 4.

The method is exemplarily described with a dispersion 1 comprising a carrier component 2, a first functional component 3 and a second functional component 4, said first functional component 3 having a lower density than the carrier component 2 and said second functional component 4 having a higher density than the carrier component 2.

The steps of the method according to the present invention will be explained hereinbelow:

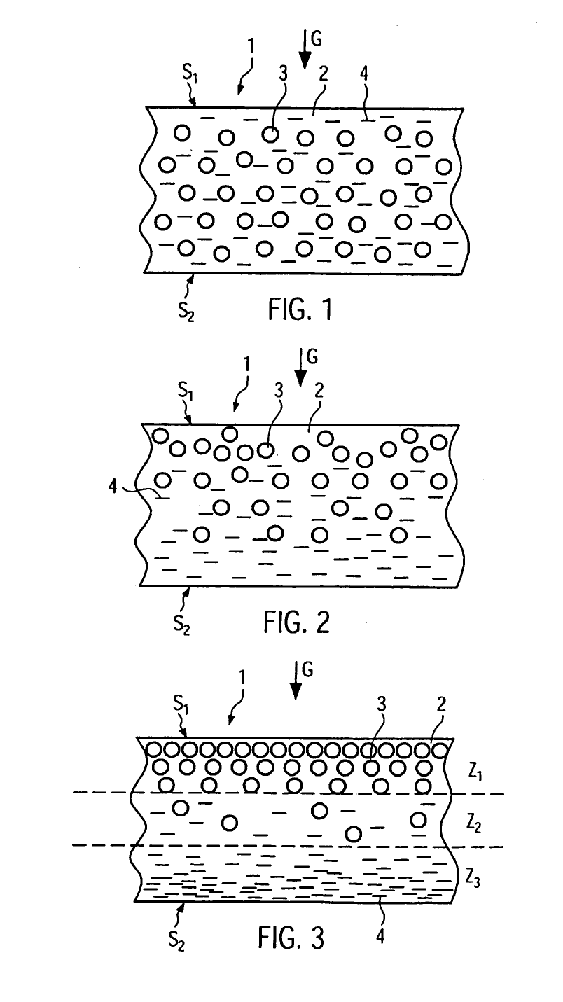

In step a), the dispersion 1 is mixed in a mixing unit in such a way that the functional components 3, 4 will be present in the carrier component 2 in discrete units and in a finely dispersed form. By stirring the dispersion 1, the functional components 3, 4 are uniformly distributed over the volume of the dispersion 1. Subsequently, the dispersion 1 is refilled into a mould which defines the contour of the functional construction element to be produced. The mould is defined e.g. by formwork panels on a formwork base. FIG. 1 shows a schematic view of the dispersion 1 after step a) of the method according to the present invention. If necessary, a reinforcing steel (not shown) can be arranged as a reinforcing component in a volume of the mould to be filled by the dispersion 1, so as to effectively reinforce the functional construction element produced in accordance with the method according to the present invention. By refilling the dispersion 1 into the mould, the reinforcing component is embedded in the dispersion 1 and encompassed by the dispersion 1.

In step b), a segregation process of the dispersion 1 is initiated. The segregation process of the dispersion 1 is initiated e.g. by leaving the dispersion 1 unstirred for a predetermined period of preferably 10 min to 90 min, preferentially 20 min to 80 min, even more preferentially 30 min to 60 min. Due to the different densities of the carrier component 2 and of the functional components 3, 4, the components of the dispersion 1 will segregate automatically under the influence of the force of gravity. By shaking the dispersion 1 or by vibrating the formwork base, the segregation process can be accelerated, if necessary. Due to the lower density, the functional component 3 ascends towards a side S1 in the carrier component 2 and, due to the higher density, the functional component 4 descends towards a side S2 in the carrier component 2. FIG. 2 shows a schematic view of the dispersion 1 in step b) of the method according to the present invention. The respective arrow designated by reference symbol G indicates the direction in which the fore of gravity is effective.

In step c), the dispersion 1 is hardened in a partially segregated state in such a way that the concentration of the functional component 3 increases towards the side S1 of the functional construction element and the concentration of the functional component 4 decreases towards the side S1 of the functional construction element. The hardening rate can be adapted to the segregation rate in such a way that a desired partially segregated state, which is particularly suitable for the desired case of use, is “frozen”. The hardening rate can be adjusted by the selection of the composition of the binder contained in the carrier component 2. The segregation rate can be influenced e.g. by shaking the dispersion 1. The higher the degree of segregation in the hardened condition is, the more functional the finished functional construction element will be. FIG. 3 shows a schematic view of the dispersion 1 after step c) of the method according to the present invention.

A preferred functional construction element which is produced in accordance with the method according to the present invention and which will be described hereinbelow with reference to FIG. 3 is implemented as a heat insulating wall element and is used e.g. as a cladding.

The dispersion 1 for producing this functional construction element comprises the following components:
carrier component 2: water/cement mixture with a water/cement ratio <=0.3, volume share of the carrier component 2 in relation to the total volume of the dispersion 1: 50% by volume;
first functional component 3; expanded clay/Liapor, volume share of the first functional component 3 in relation to the total volume of the dispersion 1: 25% by volume;
second functional component 4; sand, volume share of the second functional component 4 in relation to the total volume of the dispersion 1: 25% by volume.

The first functional component 3 has a lower density than the carrier component 2 and the second functional component 4 as a higher density than the carrier component 2.

By adjusting the hardening rate to the segregation rate, the dispersion 1 is hardened in the schematically shown, partially segregated state, so that the functional construction element comprises, between two opposed sides S1, S2, three zones Z1, Z2, Z3 having an essentially identical thickness, the first and the second boundary zones Z1, Z3 defining the opposed sides S1, S2 of the functional construction element, whereas a transition zone Z2 is defined between the two boundary zones Z1, Z3, a volume share of a functional component 3 in one of said boundary zones Z3 being <=10%, whereas in the transition zone Z2 it is >10% and <=90%, and in the other boundary zone Z1 it is >90%. In the case of the second functional component 4, the concentration values are essentially inverse to those of the first functional component 3. The concentrations of the functional components 3, 4 increase essentially linearly or exponentially between the opposed sides 51, S2 of the functional construction element, the concentration of the functional component 3 increasing towards the side S1 of the functional construction element and decreasing towards the side S2, and the concentration of the functional component 4 increasing towards the side S2 of the functional construction element and decreasing towards the side S1.

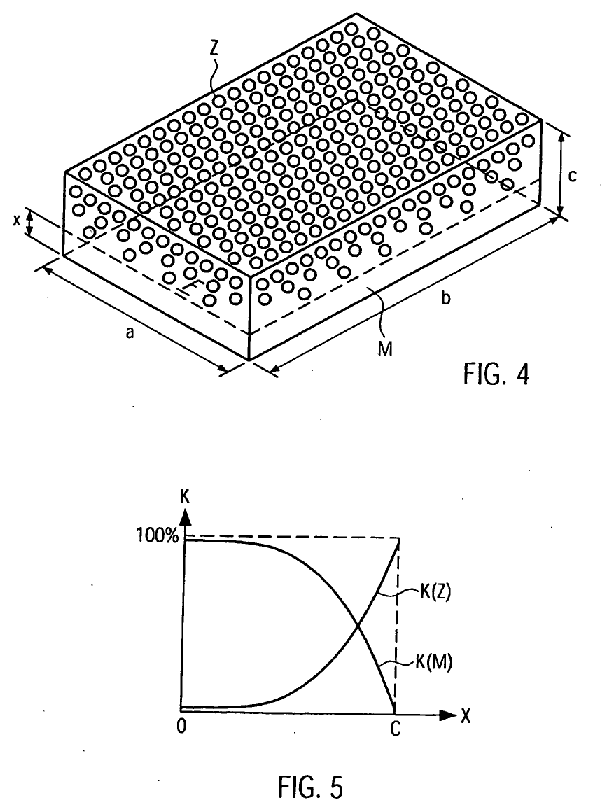

A mathematical model of a functional construction element produced in accordance with the method according to the present invention will be described hereinbelow with reference to FIGS. 4 and 5.

FIG. 4 shows a simplified perspective view of a functional construction element comprising a matrix M and an additive Z.

The functional construction plate produced in accordance with the method according to the present invention has the dimension a×b×c, wherein a×b=base area F and c=thickness. The dimensions a and b preferably lie between 50 cm and 1000 cm, preferentially between 100 cm and 500 cm, even more preferentially between 200 cm and 300 cm, and the dimension c lies preferably between 10 cm and 50 cm, preferentially between 20 and 40 cm, and even more preferentially it is approximately 30 cm. A matrix M, which is also referred to as carrier component 2 within the framework of the present description, has incorporated therein at least one additive Z, which is referred to as functional component 3, 4 within the framework of the present description, in such a way that the concentration K(Z) of this additive Z increases or decreases continuously, e.g. in dependence upon its density ρ(Z) within the matrix M, with respect to the distance X from its base area F. The concentration of the matrix K(M) with respect to the distance from the area F then results from 100−K(Z) as a function of the quality at the relevant location within the construction plate. It is important for the functional effectiveness of the construction plate that the concentration gradient of the components with respect to their distance from the area F is continuous and that an accumulation of significantly identical qualities within the construction plate is therefore excluded.

It follows that each quality value is then always defined in dependence upon its distance from the area F, according to:

dQ/dX=f(X)

wherein Q represents of the sum of the qualities.

Q=q+q²+q³ . . . q*

wherein q=compressive strength, q²=coefficient of thermal conductivity, q³=sound absorption, etc.

FIG. 5 shows a diagram for illustrating the concentrations of the matrix K(M) and of the additive K(Z) of the functional construction element in relation to the distance x from a base area F of the functional construction element.

By means of the method according to the present invention, a monolithic combinational/functional construction element is produced, within which intentionally differentiated quality features are established by creating a continuous concentration gradient of at least one functional component or of an additive Z within the monolith, so that a simultaneous multi-functional use of these characteristics across the whole functional construction element is made possible.

An exemplary concrete dispersion in the strength class C25/C30 (standard concrete) comprises the following recipe:

### Carrier Component:

| | | |
|---|---|---|
| cement | 190.00 | kg |
| fly ash | 90.00 | kg |
| rock powder, grain size < 0.125 mm | 30.00 | kg |
| water (processed/depolymerized) | 93.00 | kg |
| additive | 2.70 | kg |

### Functional Component(s):

| | | |
|---|---|---|
| sand/gravel | 2062.00 | kg |

An exemplary concrete dispersion in the strength class C35/C40 (standard concrete, highly fluid) comprises the following recipe:

### Carrier Component:

| | | |
|---|---|---|
| cement | 240.00 | kg |
| rock powder, grain size < 0.125 mm | 160.00 | kg |
| water (processed/depolymerized) | 130.00 | kg |
| additive | 4.00 | kg |

### Functional Component(s):

| | | |
|---|---|---|
| sand 0-4 mm grain size | 1111.00 | kg |
| gravel 4-8 mm grain size | 740.00 | kg |

An exemplary concrete dispersion in the strength class C8/C10 (light-weight concrete, density 800 kg/m³) comprises the following recipe:

### Carrier Component:

| | | |
|---|---|---|
| cement | 220.00 | kg |
| rock powder, grain size < 0.125 mm | 180.00 | kg |
| water (processed/depolymerized) | 120.00 | kg |
| additive | 4.00 | kg |
| foamer | 1.30 | kg |

### Functional Component(s):

| | | |
|---|---|---|
| Liapor-sand 0-4 mm grain size | 100.00 | kg |
| Liapor 8-12 mm grain size | 260.00 | kg |

An exemplary concrete dispersion in the strength class C10/C12 (light-weight concrete, sound absorbing, density 1200 kg/m³) comprises the following recipe:

### Carrier Component:

| | | |
|---|---|---|
| cement | 240.00 | kg |
| rock powder (D < 0.125 mm) | 160.00 | kg |
| water (processed/depolymerized) | 120.00 | kg |
| additive | 4.00 | kg |
| foamer | 1.20 | kg |

### Functional Component(s):

| | | |
|---|---|---|
| chopped rubber 2-8 mm grain size | 830.00 | kg |

An exemplary concrete dispersion in the strength class C55/C65 (high-performance concrete) comprises the following recipe:

### Carrier Component:

| | | |
|---|---|---|
| cement | 387.00 | kg |
| fly ash | 48.60 | kg |
| water (processed/depolymerized) | 119.00 | kg |
| additive | 6.80 | kg |

### Functional Component(s):

| | | |
|---|---|---|
| sand 0-2 mm grain size | 1960.00 | kg |

The actual masses of the components contained in the dispersion may deviate from the above-listed values by +/−10%, preferably +/−5%, preferentially <+/−1%.

1. A method for producing a functional construction element, comprising the following steps: a) producing a dispersion (1) with a liquid and hardenable carrier component (2) as a main phase and at least one functional component (3), which is dispersed in said carrier component (2), as a secondary phase; b) initiating a segregation process of the dispersion (1); and c) hardening the dispersion (1) in a partially segregated state so that the concentration of the functional component (3) will increase towards one side (S1) of the functional construction element.

2. A method according to claim 1, characterized in that the carrier component (2) contains a binder comprising at least a certain percentage of a hydraulic binder, of a latent-hydraulic binder, of a pozzolanic reacting binder, or of a plastic material.

3. A method according to claim 1, characterized in that the carrier component (2) comprises at least a certain percentage of cement, plaster, anhydrite, loam, clay, bitumen, polyurethane or of some other artificial binder.

4. A method according to claim 1, characterized in that the carrier component (2) contains a depolymerized liquid, preferably depolymerized water.

5. A method according to claim 1, characterized in that a functional component comprises a plurality of gas bubbles.

6. A method according to claim 1, characterized in that a functional component (3) comprises a plurality of solid particles.

7. A method according to claim 1, characterized in that the particles have a structure that cannot be penetrated by the carrier component (2).

8. A method according to claim 1, characterized in that the particles contain gas pockets.

9. A method according to claim 1, characterized in that the particles contain a heat insulating and/or sound absorbing material.

10. A method according to claim 1, characterized in that the particles contain at least a certain percentage of a natural substance, preferably a vegetable matter such as wood, straw, cork, natural rubber, or of a natural rock such as sand, gravel, volcanic rock such as pearlite or pumice, or of a synthetic substance such as a synthetic material, polystyrene, or of an artificial rock such as expanded clay.

11. A method according to claim 1, characterized in that the functional component (3, 4) has a density which is different from that of the carrier component.

12. A method according to claim 1, characterized in that step a) includes stirring of the dispersion (1), and/or that step b) includes shaking of the dispersion (1).

13. A method according to claim 1, characterized in that step b) includes the segregation of the dispersion (1) under the influence of the force of gravity.

14. A method according to claim 1, characterized in that a reinforcing component is embedded in the dispersion (1).

15. A method according to claim 1, characterized in that the reinforcing component comprises an armouring element.

16. A monolithic functional construction element produced by the method according to claim 1, wherein the functional construction element is implemented as a functional construction plate.

17. A monolithic functional construction element according to claim 16, characterized in that the functional construction element is implemented as a heat insulating and/or sound absorbing element.

18. A monolithic functional construction element according to claim 1, characterized in that the functional construction element comprises, between two opposed sides (S1, S2), three zones (Z1, Z2, Z3) having an essentially identical thickness, the first and the second boundary zones (Z1, Z3) defining the opposed sides (S1, S2) of the functional construction element, whereas a transition zone (Z2) is defined between the boundary zones (Z1, Z3), a volume share of a functional component (3) in one of said boundary zones (Z3) being <=25%, whereas in the transition zone (Z2) it is >25% and <=75%, and in the other boundary zone (Z1) it is >75%.

19. A monolithic functional construction element according to claim 1, characterized in that the volume share of a functional component (3) in one of said boundary zones (Z3) is <=10%, whereas in the transition zone (Z2) it is >10% and <=90%, and in the other boundary zone (Z1) it is >90%.

20. A monolithic functional construction element according to claim 1, characterized in that the concentration of a functional component (3, 4) increases essentially linearly or exponentially between two opposed sides (S1, S2) of the functional construction element.

21. A monolithic functional construction element according to claim 1, characterized in that the functional construction element comprises two functional components (3, 4) whose concentrations increase towards different sides (S1, S2) of the functional construction element.

22. A monolithic functional construction element according to claim 1, characterized in that the functional construction element is implemented as a roof element.

23. A monolithic functional construction element according to claim 1, characterized in that the functional construction element is implemented as a floor element.

24. A monolithic functional construction element according to claim 1, characterized in that the functional construction element has added thereto a dye.
